(19) United States
(12) Patent Application Publication
(10) Pub. No.: US 2013/0248221 A1
(43) Pub. Date: Sep. 26, 2013

(54) CUSHIONED CABLES

(71) Applicant: AMPHENOL CORPORATION, Wallingford, CT (US)

(72) Inventors: Carl S. BOOTH, Storrs, CT (US); Russell K. Isch, Tolland, CT (US); Timothy M. Tassmer, Wallingford, CT (US); Albert M. Ermer, JR., Seymour, CT (US); Gregory P. Vaupotic, Wallingford, CT (US)

(73) Assignee: Amphenol Corporation, Wallingford, CT (US)

(21) Appl. No.: 13/632,665

(22) Filed: Oct. 1, 2012

Related U.S. Application Data
(60) Provisional application No. 61/613,747, filed on Mar. 21, 2012.

(51) Int. Cl. H01B 7/18; H01B 19/00; H01B 11/06

(52) U.S. Cl. CPC H01B 7/189; H01B 11/06; H01B 19/00
USPC 174/103; 174/116; 29/872

(57) ABSTRACT

The invention relates to a cable having at least two pairs of insulated wires. The adjacent pairs are separated at their contact point(s) by a cushion layer that does not wrap completely around the pairs or any one of the pairs. The cable provides low variability in insertion loss or the ratio of input of voltage injected into the cable vs. output voltage.

This application claims the priority of U.S. Provision Patent Application Ser. No. 61/613,747, filed Mar. 21, 2012, which is incorporated herein by reference.

### FIELD OF THE INVENTION

The invention relates to a cable having at least two pairs of insulated wires. The pairs are separated at their contact point(s) by a cushion member that does not wrap completely around the pairs or any one of the pairs.

### BACKGROUND OF THE INVENTION

Multiple pair twinaxial copper cables are well known in the computer and telecommunications industry for transmitting digital data signals over short distances at high frequency. Some typical current industry standard application standards include Serial Attached SCSI (SAS), InfiniBand, and 10 Gb Ethernet. Cables are commonly used within corporate data centers, where multiple copper cable connections are deployed between switches, routers, hubs, servers, and storage units. In these applications it is common to employ eight twinaxial pairs in a round cable configuration, whereby four of the pairs transmit data, and four pairs receive data.

In order for data transmission to be error free, the twinaxial copper pairs must exhibit a very high degree of physical consistency relative to each other. If the pairs are physically different from each other in any way, insertion loss, which is measured as the ratio of input of voltage injected into the cable vs. output voltage can vary greatly. Furthermore, the insertion loss deviation, or the difference in loss between the lowest and highest loss pair can be greatly affected. This “insertion loss deviation” is an electrical parameter that must be controlled tightly, since pairs with too much received voltage can cause unwanted energy to couple with neighboring pairs, creating crosstalk and further data errors. In addition, insertion loss deviation forces system designers to use complicated and power hungry signal conditioning techniques to equalize received voltage as much as possible. Therefore bulk cable manufacturers go to great lengths to ensure that the pair's individual insulated wire's physical properties such as insulation diameter, ovality, and conductor concentricity are properly maintained throughout a production lot. These properties are critical to maintain, not only at the initial extrusion operation, where the insulation is applied, but also through all subsequent manufacturing operations, such as pair shielding, cabling, braiding and final jacketing.

Skew also adds to the error in data transmission. Skew is the delayed arrival of a signal from the pairs in the cable, and can be significant in a long cable. Ideally, all signals would arrive at the same time; however, physical inconsistencies between the pairs in the cable results in some signal arriving later than others. It is, therefore, desirable to reduce skew variation in the cable to reduce transmission errors.

Also important to the design of these cables is finished cable diameter, which needs to be kept to a minimum. As a result, cable manufacturers typically use a variety of air enhanced cable dielectrics in order to achieve the lowest possible diameter for a given AWG and cable impedance. Unfortunately, whenever air is introduced into a dielectric, its physical resistance to crushing and deformation is reduced according to the amount of air content.

A cable cross section of industry standard eight-pair cable is shown in FIG. 1. The process of combining the eight pairs together is commonly referred to as “cabling”. In the cabling operation, all eight pairs are simultaneously helically wound by machine around a central axis. In order to arrange the pairs in the most compact geometry, there is an inner layer of two pairs (7 and 8) which are surrounded by six pairs (1-6). Each layer is helically wound through a closing die to ensure diameter control and the proper positioning of pairs in numerical sequence. Typical industry practice uses one or more taping machines that are positioned after the closing die(s) in order to apply various industry standard EMI/RFI shields and tapes. As depicted in FIG. 1, each of the 8 pairs is taped with at least one layer of wrapping tape. These tapes are generally polymeric (e.g. polyester) and have adhesive on one side. The wrapping tapes can be wound helically or longitudinally around each of the pairs.

The center two pairs (7 and 8) are then wrapped with a first layer of tape (sometimes referred to in the industry as “binder tape” or “buffer tape”). The buffer tape is made from a soft, pliable, non-conducting tape that can cushion and absorb shock when the cable is impacted. The buffer tape is preferably made from polymers, such as foamed polypropylene, Teflon (polytetrafluoroethylene), PVC and the like, and contains no adhesive.

The remaining six pairs (1-6) are wound around the first layer of buffer tape 100. A second layer of buffer tape (100) is then wrapped around the outer pairs (1 to 6). Thus, FIG. 1 shows two distinct layers of buffer tape (100). One layer is immediately applied directly over inner pairs 7 and 8. The other layer is immediately applied directly over outer pairs 1 through 6.

Beyond the second layer of buffer tape, there can be successive layers of shielding (102) and jacket (104). As shown in FIG. 1, the shielding can include an aluminum tape and/or a braided shield. The jacket can be made from known jacketing material for communication cable.

The purpose of the multiple layers of buffer tape is to minimize any physical distortion that may happen to the pairs as a result of the cabling torque forces applied, or as a result of compressive forces applied to the cable as a result of downstream cable braiding and final jacketing operations. However, the prior art cables do not provide consistent insertion loss and skew characteristics between the pairs in the cable. Therefore, there remains a need for communication cables that reduce insertion loss and skew variability between the different pairs within a cable.

### SUMMARY OF THE INVENTION

An object of the present invention is to provide communication cables having low variability in insertion loss (the ratio of input of voltage injected into the cable vs. output voltage). The present invention provides communications cables containing a plurality of wire pairs, each pair having a binder tape completely covering the pair around their mutual circumference. The cables further include a cushioning member between at least two adjacent pairs. That cushioning member is disposed such that it prevents any direct contact between the adjacent pairs, but does not completely cover the circumference of any one particular pair. The cushioning member can be placed between selected adjacent pairs or all adjacent pairs. Preferably, a cushioning member is placed between any adjacent pairs that come into contact with each other. Applicants have discovered that the cables of the present invention provide consistent insertion loss profile without sacrificing flexibility and size of the cable.

Another object of the present invention is to provide methods for making the cables. In a preferred method, the cushioning member is cabled in with the plurality of wire pairs as the pairs are being assembled into a cable. This method avoids the difficult and costly process of adding an additional layer of wrapping tape or extruded jacket around each pair, which adds to the size and lowers the flexibility of the cable.

A further object of the present invention is to provide for methods for connecting communication equipments with the cables.

### BRIEF DESCRIPTION OF THE DRAWINGS

FIG. 1 shows the cross-section the eight pair cable of the prior art.

FIG. 2 shows the cross-section of the eight pair cable of the present invention where the cushioning member covers a minor portion of the center pairs.

FIG. 3 shows the cross-section of the eight pair cable of the present invention where the cushioning member covers a major portion of the center pairs.

FIG. 4 shows the cross-section of the eight pair cable of the present invention where the cushioning member covers only where the center pairs are in contact.

FIG. 5 shows the cross-section of a four pair cable of the present invention.

FIG. 6 shows insertion loss of the pairs in the cable depicted in FIG. 1.

FIG. 7 shows insertion loss of the pairs in the cable depicted in FIG. 4.

FIG. 8 shows the standard deviation for the insertion loss for each of the pairs, at 1.5 GHz, in the cable of the present invention (FIG. 4) and the prior art cable (FIG. 1). The numbers on the x-axis denote the wire pair as noted in the inset of FIG. 1. The “S” indicates the corresponding pair in the cable of the present invention.

FIG. 9 shows the standard deviation for the insertion loss for each of the pairs, at 2.5 GHz, in the cable of the present invention (FIG. 4) and the prior art cable (FIG. 1). The numbers on the x-axis denote the wire pair as noted in the inset of FIG. 1. The “S” indicates the corresponding pair in the cable of the present invention.

FIG. 10 shows the standard deviation for the insertion loss for each of the pairs, at 5.0 GHz, in the cable of the present invention (FIG. 4) and the prior art cable (FIG. 1). The numbers on the x-axis denote the wire pair as noted in the inset of FIG. 1. The “S” indicates the corresponding pair in the cable of the present invention.

FIG. 11 shows the standard deviation for the skew for each of the pairs in the cable of the present invention (FIG. 4) and the prior art cable (FIG. 1). The numbers on the x-axis denote the wire pair as noted in the inset of FIG. 1. The “S” indicates the corresponding pair in the cable of the present invention.

### DETAILED DESCRIPTION OF THE PREFERRED EMBODIMENTS

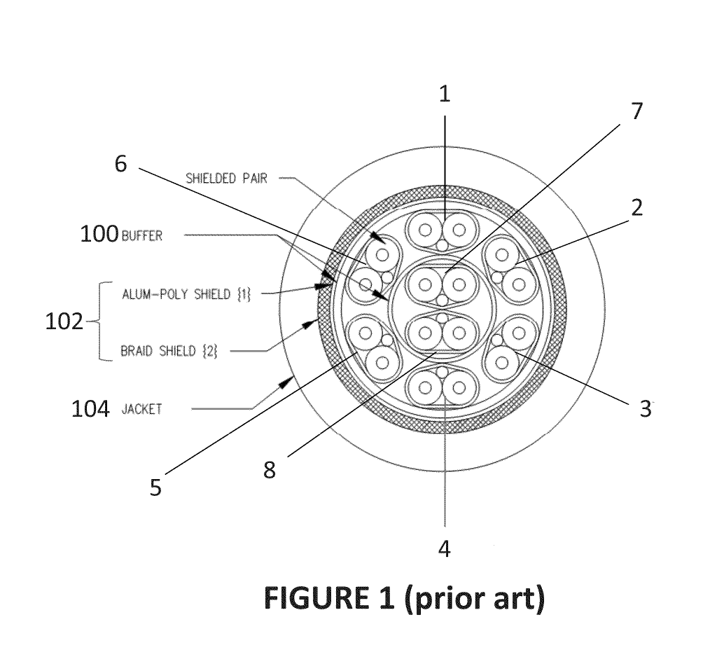

The present invention provides communication cables having consistent insertion loss profile without sacrificing flexibility of size. The communications cable of the present invention contains a plurality of wire pairs, each pair having a binder tape completely covering the pair around their mutual circumference. Each pair contains two insulated wires and a drain wire held together with a wrapping tape. Each pair can be constructed, e.g., as disclosed in U.S. Pat. No. 7,790,981 to Vaupotic et al., which is incorporated herein by reference. The plurality of pairs may further be covered by successive layers of buffer tape(s), shielding, and/or jacket as depicted in FIG. 1. The cable further includes a cushioning member between at least two adjacent pairs. That cushioning member is disposed such that it prevents any direct contact between the adjacent pairs, but does not completely cover the circumference of any one particular pair. That way, the cushioning member does not significantly increase the stiffness and the size of the cable. The cushioning member can be placed between selected adjacent pairs or all adjacent pairs. Preferably, a cushioning member is placed between any adjacent pairs that come into contact with each other. Applicants have unexpectedly discovered that the addition of the cushioning tape unexpectedly provides consistent and low variability in insertion loss or the ratio of input of voltage injected into the cable vs. output voltage.

The cushioning member provides shock dampening effect when the cable is compressed. Preferably, the dampening effect is at least the same or greater than that provided by the binder tape. The cushioning member can be made from soft, pliable, non-conductive material. The material can be polymers, such as foamed polyolefin, Teflon (polytetrafluoroethylene) or expanded Teflon, and PVC; or cloth. Preferably, the cushioning member is provided as a tape and contains no adhesive.

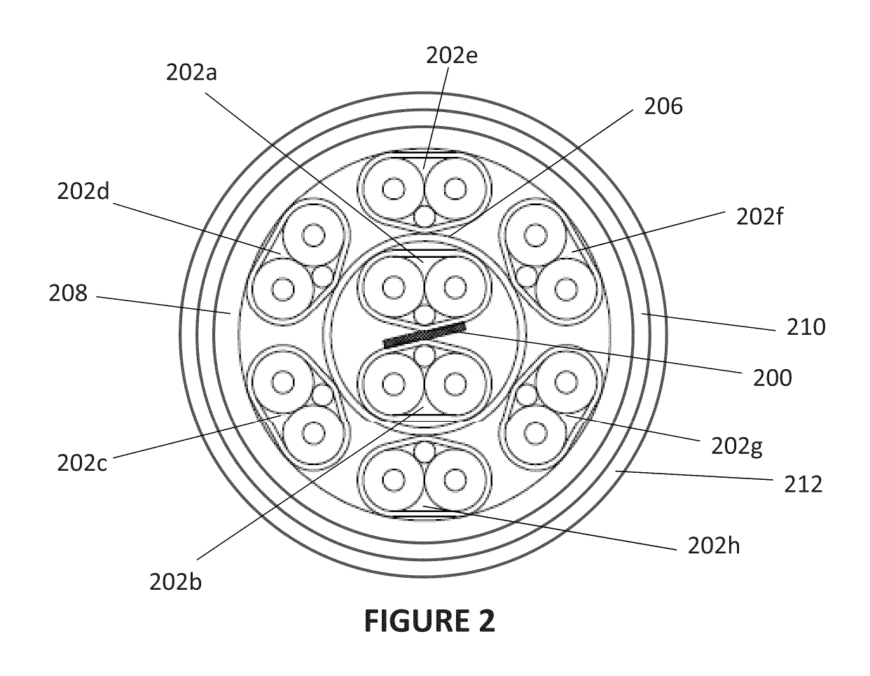

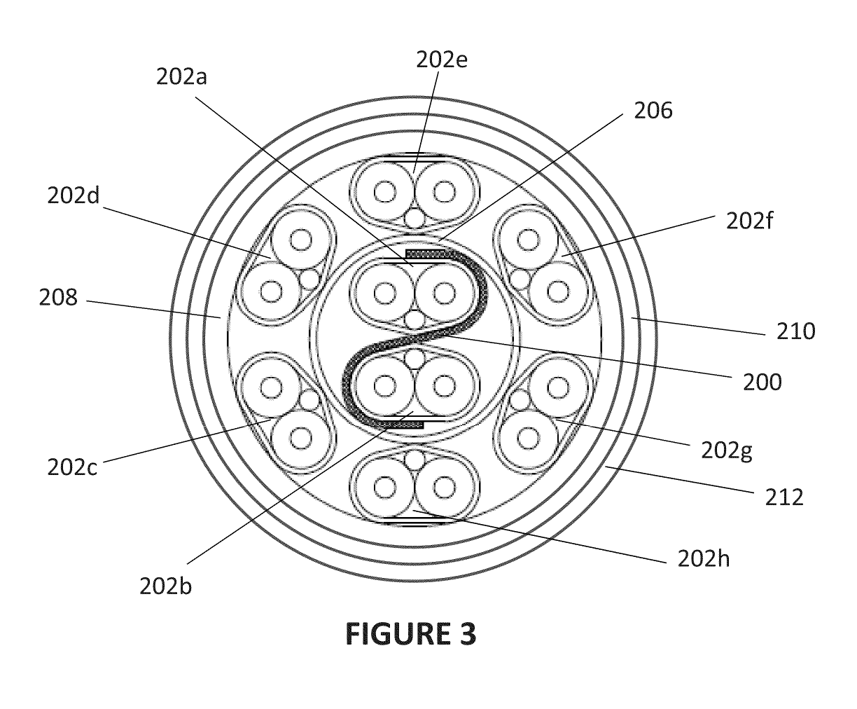

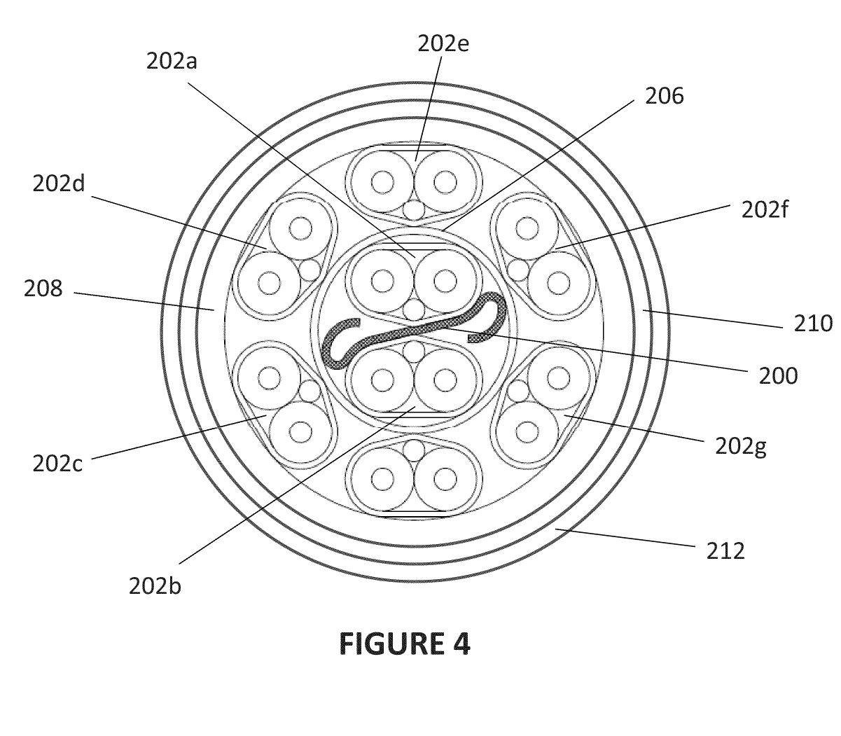

FIG. 2 depicts an embodiment of the present invention having eight pairs of wires (202a-202h). Similar to FIG. 1 (prior art), the pairs are also positioned with two pairs (202a and 202b) at the center and the other six pairs (202c-202h) surrounding the center pair. In addition to the inner and outer buffer tape layers (206 and 208), the shielding layer(s) (210), and the jacket (212), the present invention provides a cushioning member (200) between the center pairs (202a and 202b) of the cable. That cushioning member 200 functions to eliminate any direct physical contact between pair 202a and pair 202b. Preferably, the cushioning member (200) does not completely cover any of the pair it is in contact with. As shown in FIG. 2, the cushioning member (200) is inserted between pair 202a and pair 202b, but only partially covers the circumference of those pairs. In FIG. 2, the cushioning member (200) covers a minor portion of each pair 202a and pair 202b, while in FIG. 3, the cushioning member (200) also covers a major portion of each pair 202a and pair 202b. Further, the cushioning member (200) can also be disposed as depicted in FIG. 4, where the cushioning member (200) is in contact with the pairs at a point where the pairs would have been in contact but for the cushioning member (200). The remaining parts of the cushioning member need not be attached to any one of the adjacent pairs. All of those embodiments are within the scope of the present invention. It is important to note that the cushioning member provides a minimum of one separate layer of plastic material between pairs 202a and 202b. Additional, layers between those pairs are also contemplated by the present invention. Further, although FIGS. 2-4 show only a single cushioning member (200) between pair 202a and 202b, the present invention also contemplates the use of the cushioning member between any contact point of the other pairs (202c-202h). For example, consistent with the present invention, cushioning member(s) can be disposed between pairs 202c and 202d, 202d and 202e, 202e and 202f, 202f and 202g, 202g and 202h, and/or 202h and 202c.

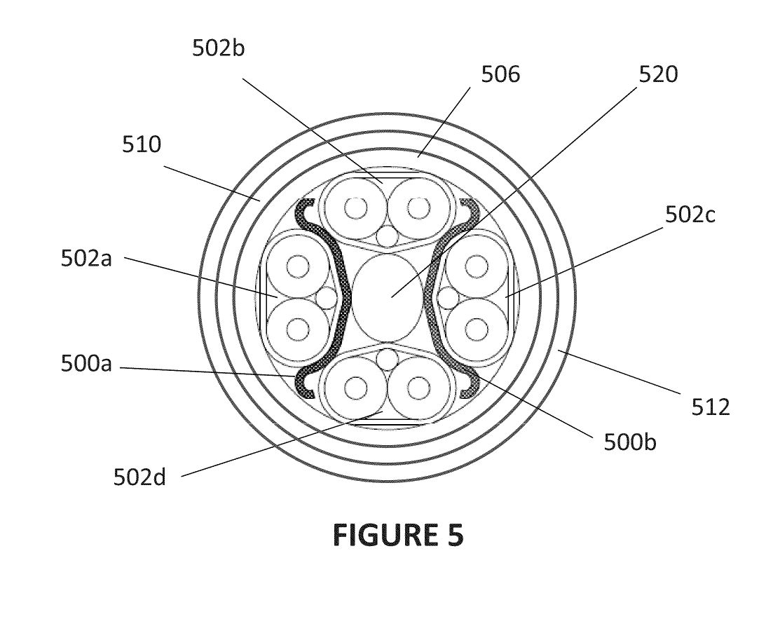

FIG. 5 depicts an embodiment of the present invention having four pairs of wires (502a-502d). The four pairs are arranged around a filler (520) which serves to fill the void between the pairs to prevent the pairs from shifting within the cable and to maintain the cross-sectional shape of the cable. Similar to the other embodiments, the four pairs may further be successively covered in a buffer tape layer (506), a shielding layer(s) (510), and/or a jacket (512). The cushioning members (500) are preferably disposed between the contact points of pairs 502a and 502b, pairs 502b and 502c, pairs 502c and 502d, and pairs 502d and 502a. As depicted in FIG. 5, two separate cushioning tapes (500a and 500b) are used to cushion the four contact points. Here, tape 500a is positioned such that it cushions the contact points between pairs 502a and 502b and pairs 502a and 502d. Likewise, tape 500b is positioned so that it cushions the contact points between pairs 502b and 502c and pairs 502c and 502d. Although FIG. 5 shows two cushioning members, the present invention also contemplates the use, for example, of four different cushioning tapes, each being disposed between one of the four contact points.

During assembly of the cable, the cushioning member(s) are preferably helically wound into the cable with a cable lay identical to that of the pairs. That way, the tools and machines for assembling the cable need only add equipments for handling the cushioning member(s) without drastically changing the original machine. Further, directly cabling in the cushioning member during the assembly of the cable provides a much simpler process than separately wrapping or extruding a jacket for each pair.

Although the Figures show only four or eight pairs of wires, the present invention is also applicable to other cable configurations as long as at least two pairs are separated by a cushioning member to prevent direct contact between the pairs.

### EXAMPLE

The cable of the present invention was compared the prior art cable. The prior art cable were constructed as shown in FIG. 1; the cables of the present invention were constructed as shown in FIG. 4. The cables were tested for insertion loss and skew. The data for the cable of the present invention was collected from 21 cable samples consisting of 168 individual measurements. The data for the prior art cable was taken from an in-house database that include all test data from the previous six months.

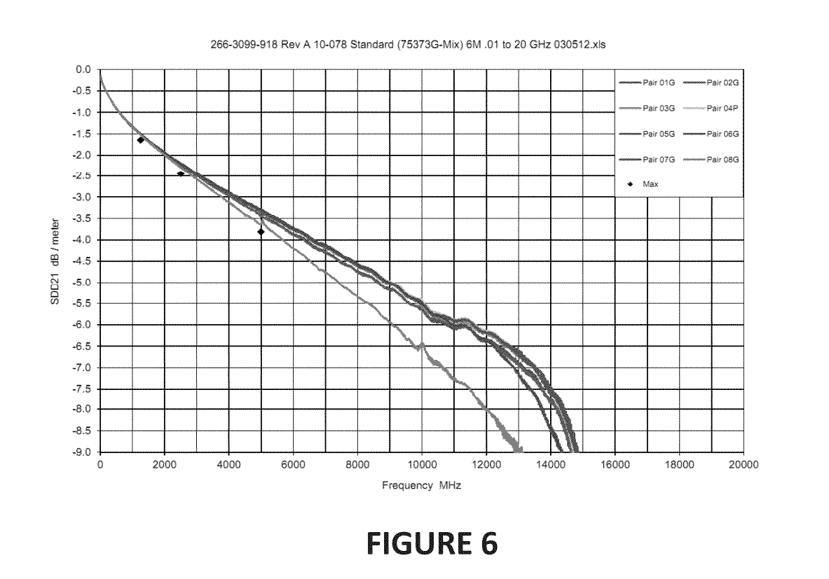

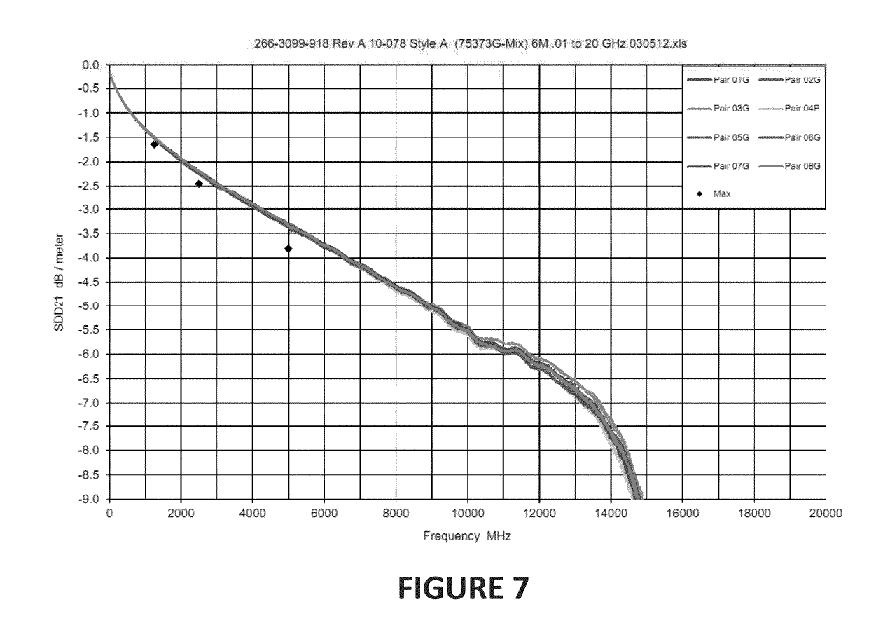

FIG. 6 shows insertion loss of a prior art cable. Note pair number 8 falls outside the grouping and close to the black dot spec limit. This is likely due to physical deformation of the pair during the cabling operation. FIG. 7 shows the cable of the present invention. Note that the cable of the present invention provided improvement in pair number 8 and in the overall tighter distribution of insertion loss.

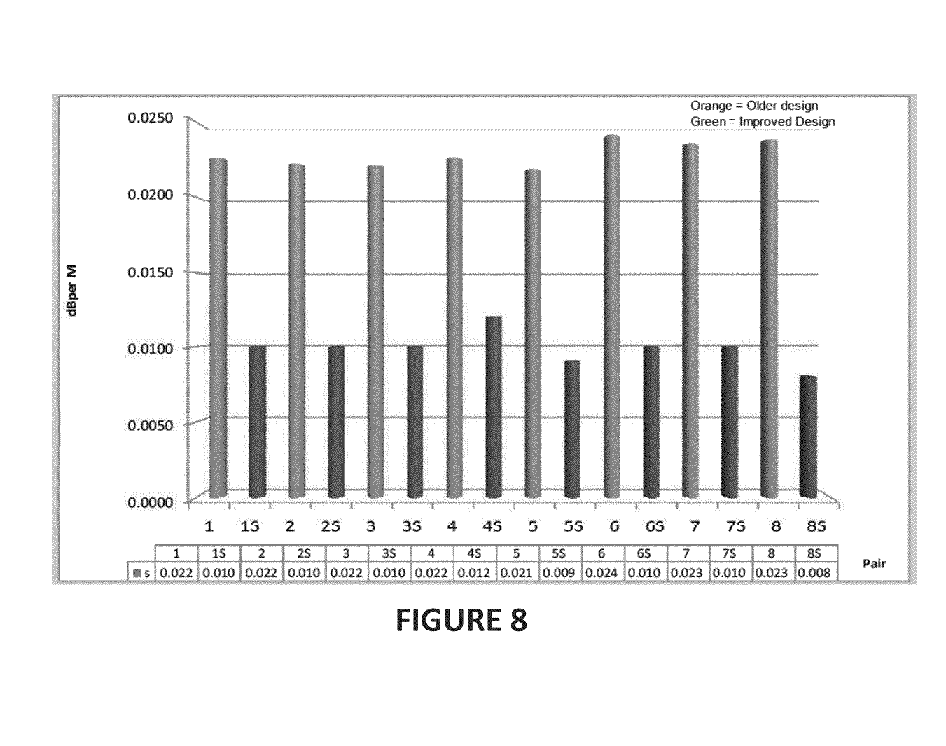

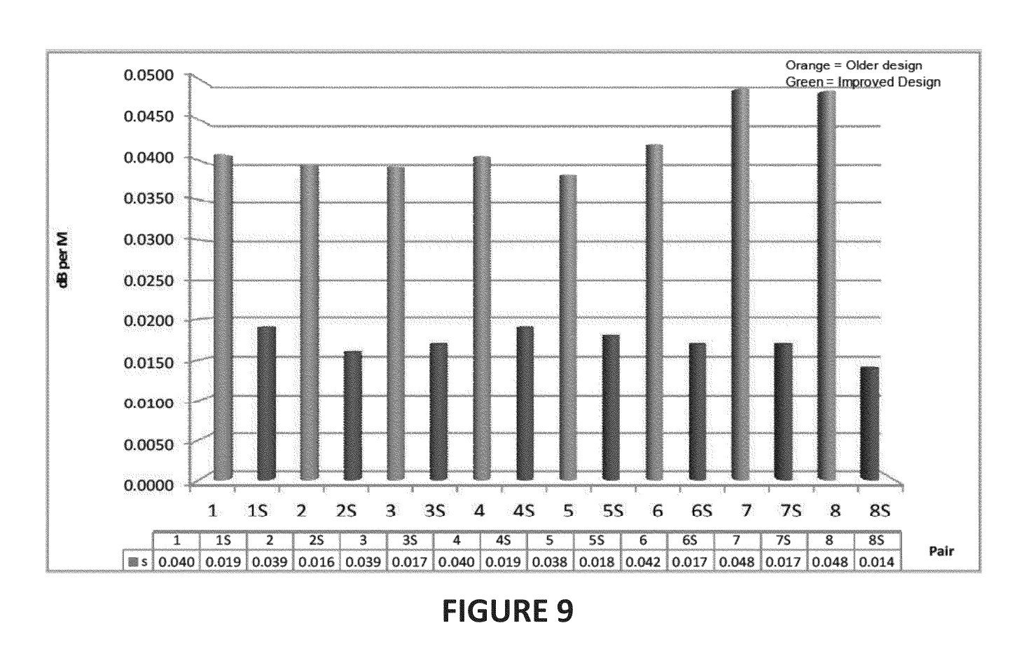

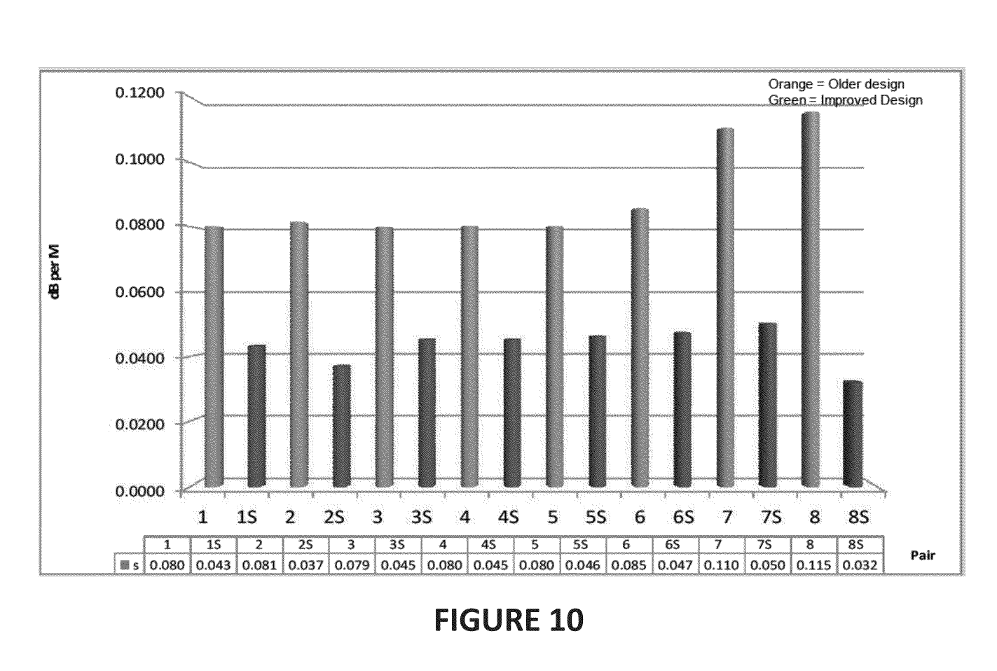

FIGS. 8-10 show the standard deviation of the insertion loss for each of the pairs in the cables at 1.5, 2.5, and 5.0 GHz, respectively. The cable of the present invention provided much lower variability in insertion loss when compared to the prior art.

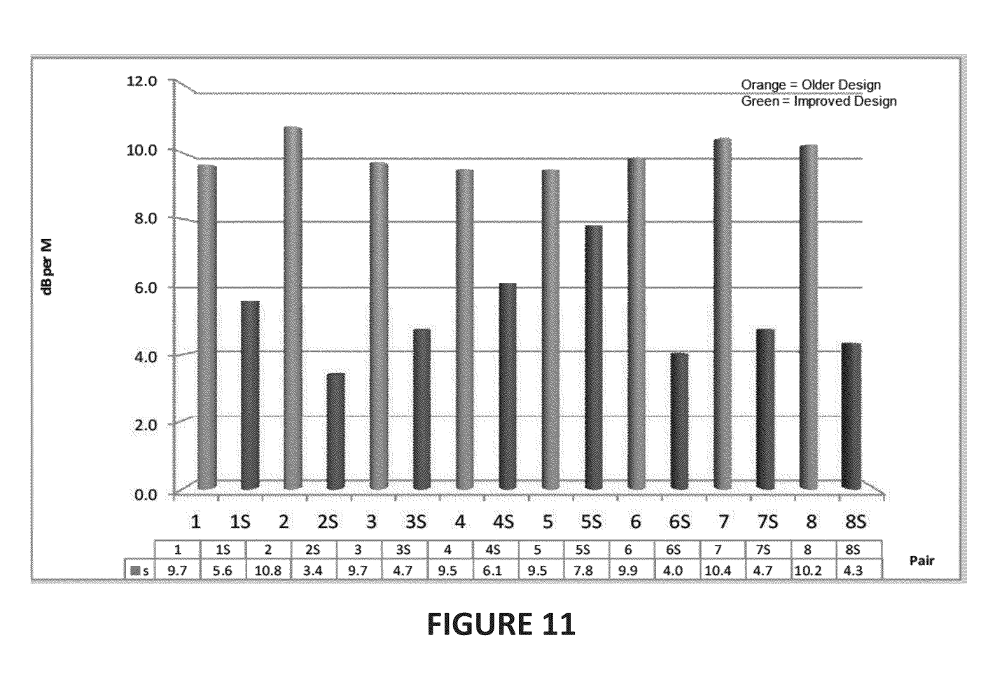

FIG. 11 shows the standard deviation of the skew for each of the pairs in the cables. The cable of the present invention provided much lower variability in skew when compared to the prior art.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A cable comprising
a plurality of pairs of wires, each pair comprises two insulated wires that are covered with at least one layer of wrapping tape; and
at least one cushioning member disposed between two adjacent pairs to prevent direct contact between said two adjacent pairs.

2. The cable of claim 1, wherein the cushioning member is made from a soft, pliable material.

3. The cable of claim 1, comprising eight pairs of wires.

4. The cable of claim 1, wherein two pairs are positioned at a center with six pairs disposed around the two pairs at the center.

5. The cable of claim 4, wherein the at least one cushioning member is positioned between the center two pairs.

6. The cable of claim 4, further comprising a first layer of buffer tape surrounding the two center pairs.

7. The cable of claim 6, wherein the six pairs are positioned around the first layer of buffer tape.

8. The cable of claim 7, further comprising a second layer of buffer tape surrounding the additional pairs of wires.

9. The cable of claim 8, further comprising at least one shielding layer surrounding the second layer of buffer tape.

10. The cable of claim 9, wherein the at least one shielding layer comprises a metal tape layer and/or a braided shield layer.

11. The cable of claim 10, further comprising a jacket surrounding the at least one shielding layer.

12. The cable of claim 1, wherein the layer of cushioning tape partially covers the perimeter of each of the two center pairs.

13. The cable of claim 1, comprising four pairs of wires.

14. The cable of claim 13, wherein the four pairs of wires are positioned around a center filler.

15. The cable of claim 14, wherein the at least one at least one layer of cushioning member contains two cushioning members disposed to prevent direct contact between the adjacent pairs.

16. The cable of claim 15, further comprising a buffer tape surrounding the four pairs.

17. The cable of claim 16, further comprising at least one shielding layer surrounding the second layer of buffer tape

18. The cable of claim 17, further comprising a jacket surrounding the at least one shielding layer.

19. A method for making a cable comprising the steps of
a. providing a plurality of pairs of wires, each pair comprises two insulated wires that are covered with at least one layer of wrapping tape;
b. providing at least one cushioning tape; and
c. assembling the cable by placing the at least one cushioning tape between two adjacent pairs, such that the cushioning tape prevents direct contact between said two adjacent pairs.

20. The method of claim 19, step c comprises helically winding the cushioning tape and the plurality of pairs with an identical cable lay.
